(19) United States
(12) Patent Application Publication
(10) Pub. No.: US 2002/0156809 A1
(43) Pub. Date: Oct. 24, 2002

(54) Apparatus and method for locating and presenting electronic content

(76) Inventor: Thomas A. O'Brien, Cincinnati, OH (US)

Correspondence Address: Pennie & Edmonds, LLP, 3300 Hillview Avenue, Palo Alto, CA, 94304, US

(21) Appl. No.: 09/800,563

(22) Filed: Mar. 7, 2001

(51) Int. Cl. G06F 15/00

(52) U.S. Cl. 707/505

(57) ABSTRACT

According to the invention, a list of question words is presented to the user. The user then selects a question word and transmits the selection to the system. The system then generates a list of question syntax forms associated with the selected question word and presents this list of question syntax forms to the user. Each question syntax form has one or more terms missing from the question. The system acquires from the user the identity of a question syntax form from the list of question syntax forms and data for combining with the identified question syntax form to construct the user's complete question. The system then searches an electronic database for an answer to the question and transmits this information to the user in response to the user's question.

### TECHNICAL FIELD

The present invention relates to an apparatus and method for locating electronic content from a database and presenting such content. More particularly, the invention relates to an apparatus and method for constructing user questions using predefined question words and question syntax forms, and supplying the answers to such questions to a user.

### BACKGROUND OF THE INVENTION

Very often, users of a computer network desire information stored in an electronic database. For example, an Internet user may desire information about particular goods or services sold over the Internet. This information is generally stored in electronic databases that are located on Web servers. Finding the desired information in these electronic databases, however, can be difficult.

Typically, information required by network users is presented in one of two formats. First, a content provider may provide a list of Frequently Asked Questions (FAQs) for the user to search. A FAQ is a list of questions followed by answers to the questions. For example, a content provider that sells goods over the Internet will provide a FAQ containing questions about the goods followed by answers to the questions. A user scrolls through this list of questions to find the question and corresponding answer the user requires. This can be futile, however, because the user's question may not be listed on the FAQ list. It is also time consuming because the user must scroll through the entire list of questions and answers to find the relevant information.

A second way of presenting information to a user is by using a search engine to search the database. Free text or natural language search engines, such as ASK JEEVES™, often fail to understand a user's request and return a multiplicity of irrelevant results. One reason for the unsatisfactory performance of such search engines is that a user may use search terms or keywords that are not recognized by the search engine. This may happen if a user simply enters keywords because there is no context by which to interpret the meaning of a few keywords. On the other hand, if a user enters complete sentences, it may be difficult for the search engine to interpret the sentences due to the length and complexity of the text. Another reason search engines return inaccurate results is that it may be difficult for a user to enter an appropriate search string due to the complexity of the Boolean interface used by most search engines. Finally, typing out a complete question or even just keywords and search terms may be impractical where the user interface is not conducive to typing large amounts of text as is the case with many wireless applications, such as when using a Personal Digital Assistant (PDA) or cellular telephone.

Therefore, in light of the above problems, an easier and more accurate means for searching an electronic database and presenting information to a user is highly desirable.

### SUMMARY OF THE INVENTION

The above problems are addressed by providing an apparatus and method for locating and presenting information that enables users to quickly and accurately ask unique questions through a computer, World Wide Web, or wireless interface without typing out the full question.

According to the invention, there is provided an apparatus and method of locating and presenting electronic content to a user. The system presents a list of question words to the user. The user then selects a question word and transmits the selection to the system. The system then generates a list of question syntax forms associated with the selected question word and presents this list of question syntax forms to the user. Each question syntax form has one or more terms missing from the question. The system acquires from the user the identity of a question syntax form from the list of question syntax forms and data for combining with the identified question syntax form to construct the user's complete question. The system then searches an electronic database for an answer to the question and transmits this information to the user in response to the user's question.

An advantage of the present invention is that a user does not need to review a long list of questions and answers, most of which are irrelevant to the user's needs, such as when using a FAQ list. A further advantage is that a user does not have to enter a relatively long (and potentially complex) string of text into a search engine which may lead to inaccurate results and may be impractical on wireless or PDA devices.

### BRIEF DESCRIPTION OF THE DRAWINGS

For a better understanding of the invention, reference should be made to the following detailed description taken in conjunction with the accompanying drawings, in which:

FIG. 1 depicts a block diagram of a computer network in accordance with one embodiment of the present invention;

FIG. 2 depicts a block diagram of a computer network in accordance with an alternative embodiment of the present invention;

FIG. 3 depicts a block diagram of an information server for providing user information in accordance with an embodiment of the present invention;

FIG. 4 depicts a flow diagram of a method for generating a question according to a preferred embodiment of the present invention;

FIG. 5 depicts an example of a user interface on the information server shown in FIG. 3;

FIG. 6 depicts a continuation of the flow diagram shown in FIG. 4;

FIG. 7 depicts a continuation of the flow diagram shown in FIG. 6; and

FIG. 8 depicts an embodiment of a database for information in the information server shown in FIG. 3.

Like reference numerals refer to corresponding parts throughout the drawings.

### DETAILED DESCRIPTION OF THE INVENTION

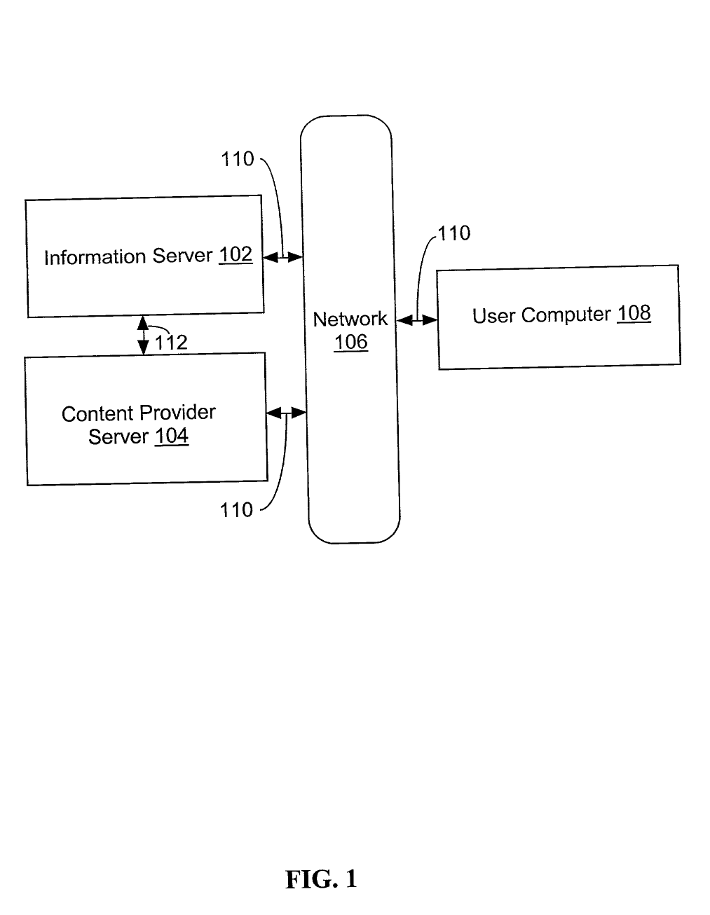

FIG. 1 is a block diagram of a computer network in accordance with an embodiment of the present invention. A content provider server 104 is a computer server, preferably a Web server, run by a content provider that provides content via a computer network 106. The content provider may be, for example, an on-line retailer or manufacturer, on-line financial service provider, non-commercial organization, or the like.

The computer network 106 is an electronic network, such as an Intranet, a wireless network, or preferably, a global computer network such as the Internet. The user computer 108 is preferably a digital computer operated by a user looking for content or information. The user computer 108 preferably connects to the computer network 106 using any suitable means, such as MICROSOFT'S INTERNET EXPLORER™, NETSCAPE'S NAVIGATOR™ via a communication interface circuit which preferably comprises a modem or Network Interface Card (NIC).

The information server 102 is a computer server, preferably a web server, that provides the information or content to the user. The information server 102 may be operated by an independent entity or it may be operated by the content provider. If, for example, the content provider server 104 is run by an on-line retailer, the information server 102 may provide information about those items for sale, and the information server 102 may be run by the same on-line retailer or it may be run by an independent entity.

Communication links 110 connect the information server 102, the content provider server 104, and the user computer 108 to the network 106. Communication links 112 also preferably connect the content provider server 104 to the information server 102. Alternatively, the content provider server 104 and the information server 102 may communicate through the computer network 106. The communication links 110 and 112 are preferably coaxial cable, copper wire, optical fiber, wireless, microwave, satellite links, or the like.

In illustrative operation, when a user at a user computer 108 is searching for information about a particular product over the Internet, the content provider server 104 delivers a Web page to the user computer 108 describing the product that the user is looking for and directing the user computer 108 to the information server 102 for further information. The user links to the information server 102 and receives the information via the computer network 106. Preferably, the information server 102 delivers the information within a Web page frame run by the content provider 104, where the Web page frame is an independently controllable section of a Web page. Alternatively, the information server 102 delivers a new Web page to the user containing the information. The use of pop-up screens, multimedia, etc. may also be used to present the information to the user.

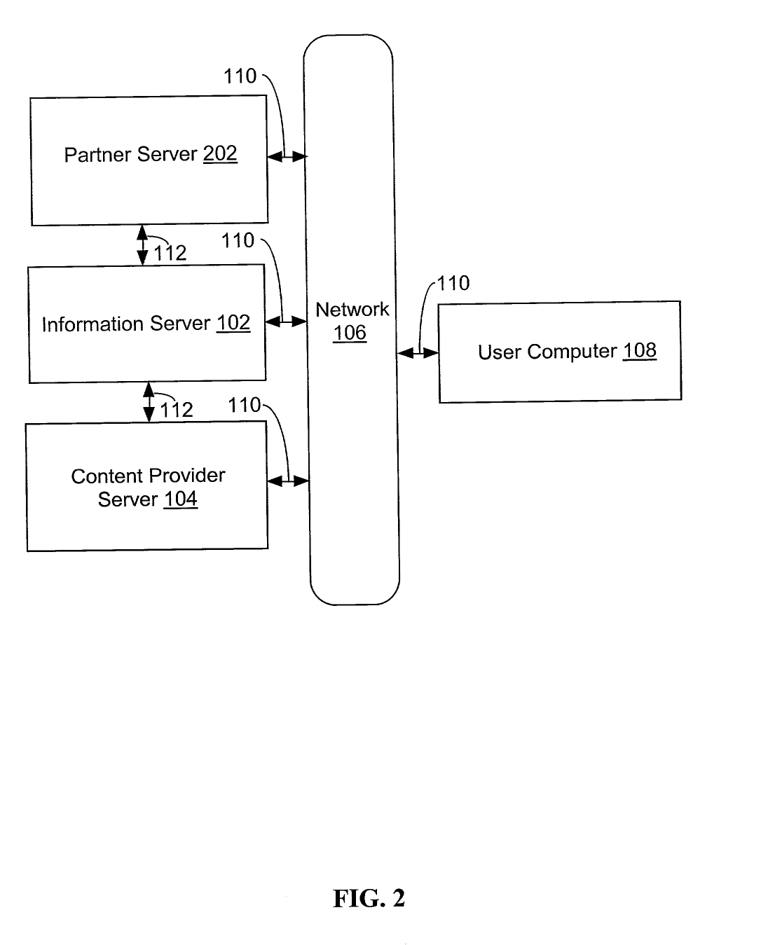

Turning to FIG. 2, in an alternative embodiment, an information server 102, a content provider server 104, and a user computer 108 are connected via network 106, as in FIG. 1, and information server 102 is also coupled to a partner server 202. The partner server 202 is a computer server, preferably a Web server, that is run by a partner associated with the content provider. For example, the content provider may be a commercial retailer selling a product to the user, and the partner may be the manufacturer of the product. In this embodiment, the information server 102 receives information about the product from the manufacturer of the product (partner server 202), not the retailer, even though the content provider server 104, preferably run by a retailer, directs the user computer 108 to the information server 102. The information server 102 communicates with the partner server 202 preferably via links 112 or, alternatively, via the computer network 106.

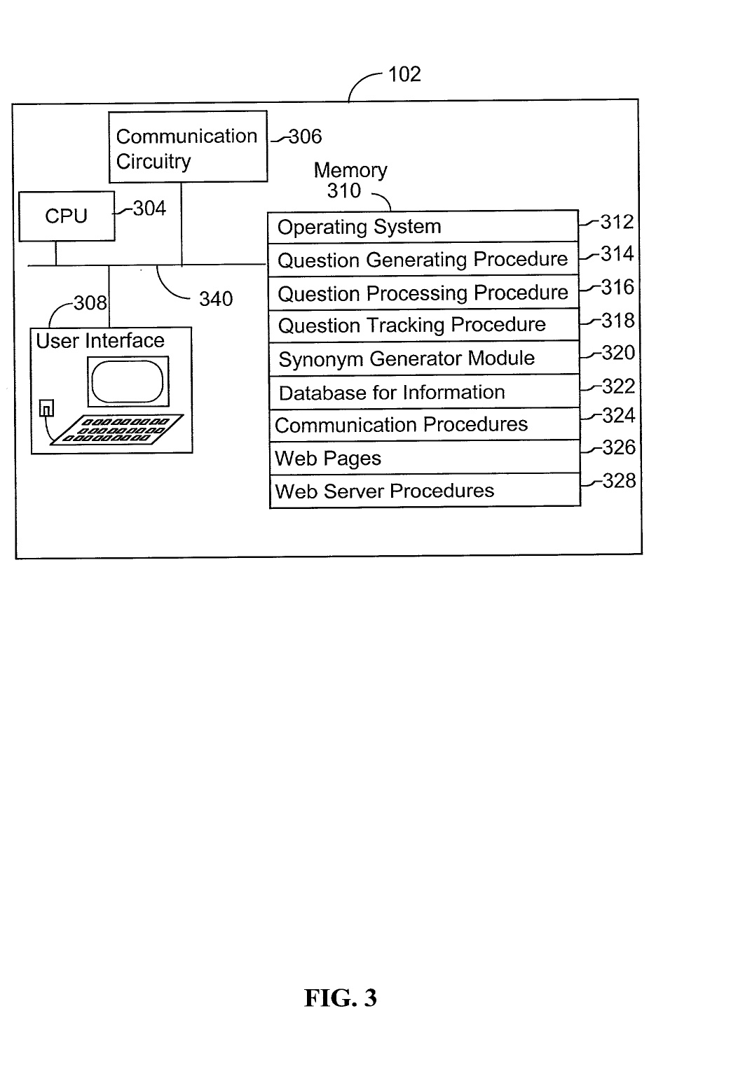

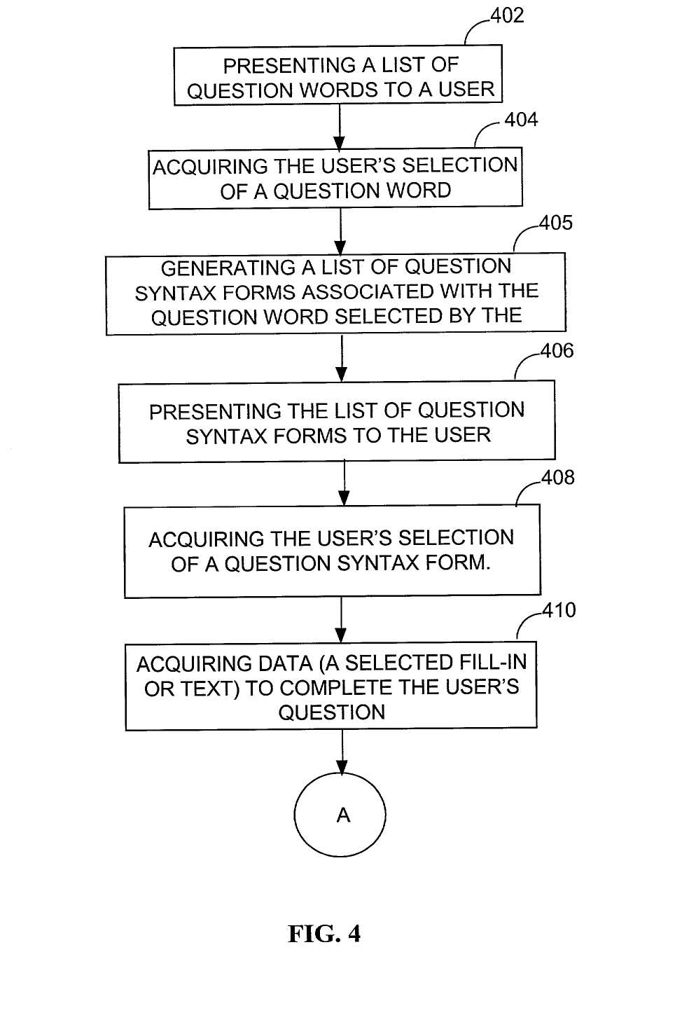

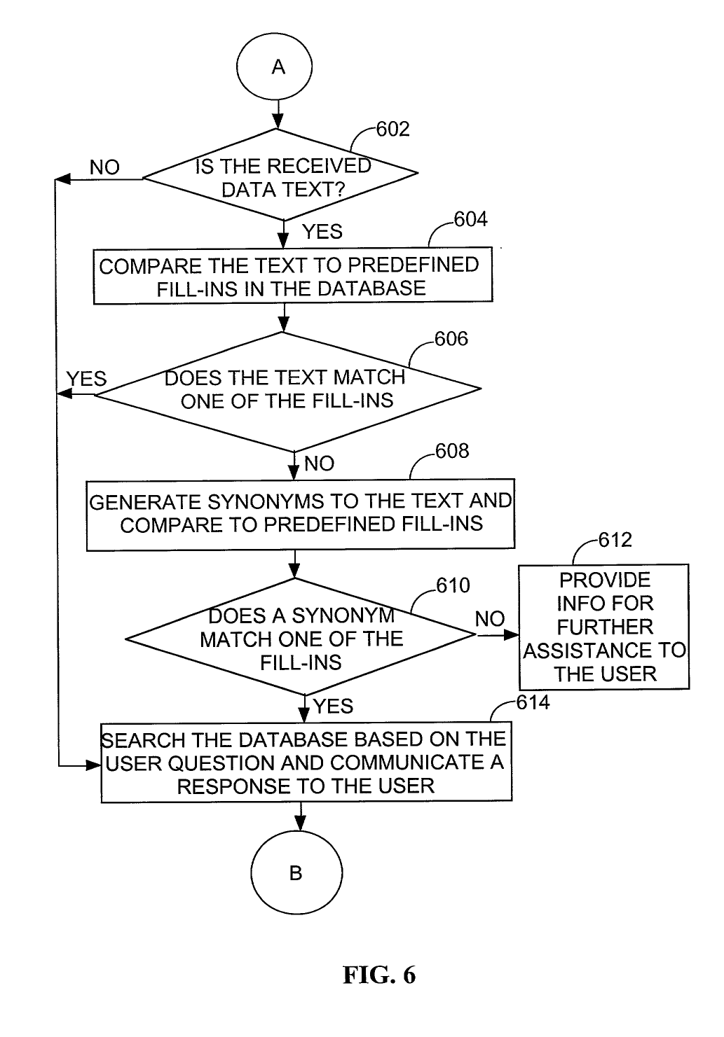

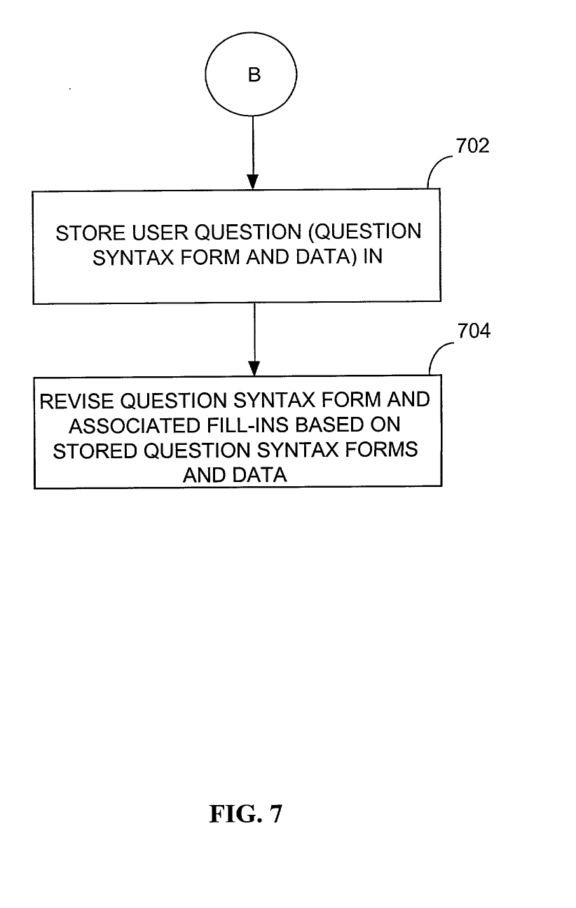

FIG. 3 is a block diagram of the information server 102 shown in FIGS. 1 and 2. The information server 102 preferably includes communications circuitry 306 for communicating with the user computer 108 (FIG. 1), the content provider server 104 (FIG. 1), computer network 106 (FIG. 1), and the partner server 202 (FIG. 2). The information server 102 further includes one or more CPUs 304, a user interface 308 (which may be remotely located on another computer), a memory 310, and a bus 340 that interconnects the aforementioned components. The memory 310 preferably includes: an operating system 312 for managing the programs stored in memory 310; a question generating procedure 314, described in detail in FIG. 4; a question processing procedure 316, described in detail in FIG. 6; a question tracking procedure 318, described in detail in FIG. 7; a synonym generator 320 for generating synonyms to the text entered by a user; a database for storing the information 322; and communication procedures 324. The memory 310 preferably also contains Web pages 326 that are delivered to user computers using Web server procedures 328.

FIG. 4 depicts a flow diagram of a method for generating a question as controlled by the question generating procedure 314 of FIG. 3. When a user is searching a computer network 106 (FIG. 1) for information, the user computer 108 (FIG. 1) is directed to the information server 102 (FIG. 1) as described above. The question generating procedure 314 is then initiated.

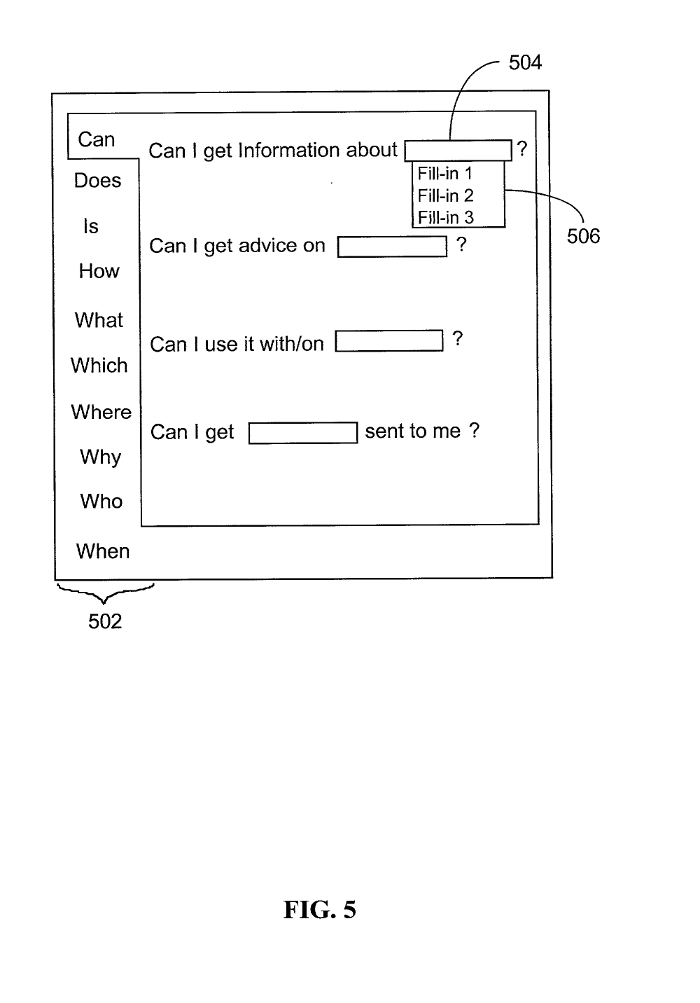

First, the question generating procedure 314 (FIG. 3) presents (step 402) a list of question words to the user. This preferably occurs by providing a user with a Web page or a frame within a Web page containing the list of question words. An example of such a list is depicted by reference numeral 502 of FIG. 5.

As used herein, the question words are words that typically begin a question. In the preferred embodiment, the question words include: can, does, is, how, what, which, where, why, who, and when. Other question words may be more suitable depending upon the type of information stored in the information database 322 (FIG. 3). Starting from the question word, the user builds his or her question in order to obtain the desired information. The question generating procedure 314 (FIG. 3) acquires (step 404) the user's selection of a question word, for example, by the user's positioning a mouse pointer above the question word. Upon selection of the question word, the question generating procedure 314 (FIG. 3) generates (step 405) a list of question syntax forms associated with the question word selected by the user and presents (step 406) them to the user. Question syntax forms are questions that have a term or multiple terms missing from the question. The missing terms are preferably one to three words and they are preferably nouns, but they may be verbs.

Turning to the example shown in FIG. 5, selecting “can” may reveal four question syntax forms: “Can I get Information about ______?”, “Can I get advice on ______?”, “Can I use it with/on ______?”, “Can I get ______ sent to me?”. The question syntax forms are preferably five words or fewer, but they should be broad enough that they are useful for finding information about a variety of products or services.

Referring again to FIG. 4, selecting a question syntax form (step 408) automatically reveals a list of fill-ins for filling in the blanks of the question syntax forms. An example of such a list is depicted by reference numeral 506 of FIG. 5. Each list of fill-ins preferably contains three words or fewer in order to limit the questions to a concise, simple idea. The question generating procedure 314 (FIG. 3) preferably displays the fill-ins as a pull-down menu underneath the blanks in the question syntax forms and prompts the user to enter data to complete the question. This data is preferably a selection of a fill-in or keyed-in string of text.

In the example of FIG. 5, the user has selected the first question syntax form, “Can I get Information about ______?”. Upon selection of the question syntax form, the question generating procedure 314 (FIG. 3) presents the pull-down menu 506. Referring to FIG. 4, the question generating procedure 314 (FIG. 3) acquires (step 410) the data to complete the question when the user selects a fill-in to combine with the question syntax form. Alternatively, the user may enter text (step 410) in the blank text box 504 (FIG. 5) in the question syntax form. Thus, in FIG. 5, the user may choose a fill-in, such as “fill-in 2”, from the pull-down menu 506, or the user may enter free text in the blank text box 504.

FIG. 6 depicts a continuation of the flow diagram shown in FIG. 4. After the user has entered the question (step 410, FIG. 4), the information server runs the question processing procedure 316 (FIG. 3). First, the question processing procedure 316 (FIG. 3) determines (step 602) whether the user entered free strings of text or selected a fill-in. If the user selected a fill-in and did not enter text (step 602-No), the question processing procedure 316 (FIG. 3) searches (step 614) the database 322 (FIG. 3) based on the user question and communicates (step 614) the response to the user. The response to the user's question is preferably brief (i.e. two or three sentences). The response may also direct the user to a more detailed explanation.

If the user entered free text (step 602-Yes), the question processing procedure 316 (FIG. 3) compares (step 604) the free text to the predefined fill-ins in the database 322 (FIG. 3). In the preferred embodiment, the question processing procedure 316 (FIG. 3) searches the database, finds the list of fill-ins, and compares (step 606) them to the entered text. If the text matches a fill-in (step 606-Yes), the question processing procedure 316 (FIG. 3) searches (step 614) the database to find the answer to the question corresponding to the fill-in and communicates (step 614) the answer to the user.

If the text does not match a fill-in (step 606-No), the question processing procedure 316 (FIG. 3) generates synonyms to the text and compares (step 608) the synonyms to the predefined fill-ins. These synonyms are preferably stored in the database 322 (FIG. 3). Alternatively, a synonym generator module 320 (FIG. 3) generates the synonyms. If no synonym matches a fill-in (step 610-No), the question processing procedure 316 (FIG. 3) provides (step 612) information to the user for further assistance. The information is preferably a telephone number for the user to call, but may also be an on-line messaging service, an on-line chat room, a Web site, an email link, or a live help link that will provide the user with further assistance. If a synonym matches one of the fill-ins (step 610-Yes), the question processing procedure 316 (FIG. 3) searches (step 614) the database and communicates (step 614) to the user an answer to his question.

FIG. 7 depicts a continuation of the flow diagram shown in FIG. 6. The information server 202 (FIG. 2) may track the questions that users enter. After it processes the user questions, the user tracking procedure 318 (FIG. 3) stores (step 702) the user question, including the question syntax form and the corresponding entered text or selected fill-in in the database 322 (FIG. 3).

This tracking allows the question syntax forms and the fill-ins to evolve over time. Those question syntax forms or fill-ins that are used infrequently may be replaced or edited (step 704). In addition, because the text entered by the user is tracked, the terms entered by users most frequently may be added to the list of fill-ins 506 (FIG. 5) presented to the user. Where the user entered text rather than selected a fill-in, the text (or a synonym) may be added to the list of fill-ins 506 (FIG. 5) along with a corresponding answer.

Finally, the tracked information can be used by the content providers or the partners to determine the information users find most desirable. The content providers or partners can make adjustments to their user interfaces based on this information. For example, a content provider that sells clothing over the Internet may find that users, after viewing the initial description of a particular item of clothing, are asking for the available colors for that item of clothing. The content provider may amend its Web site to include the available colors for that clothing item in the initial description for the item.

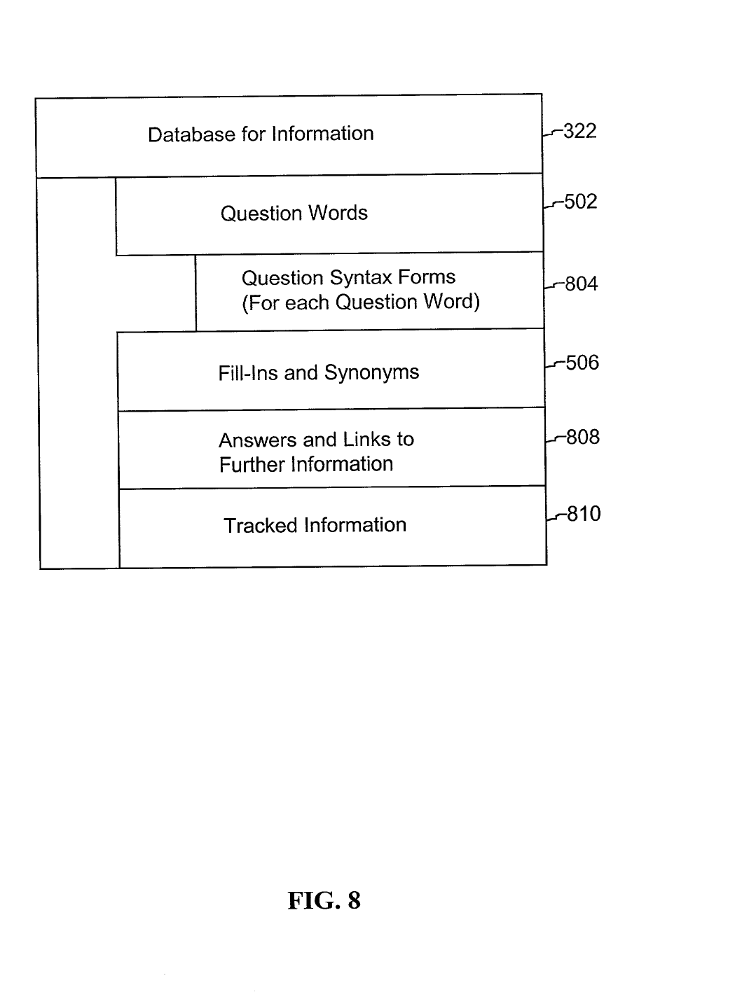

Referring to FIG. 8 there is shown an embodiment of the database for information 322 (FIG. 3). The database 322 contains the question words 502 along with the corresponding question syntax forms 804. The database 322 also contains the fill-ins 506. The database preferably stores the fill-ins 806 according to the subject or the item about which users will be searching for information. For example, a manufacturer may organize each set of fill-ins according to its product types. When a user forms a question, the user will use the set of fill-ins corresponding to the product about which the user is enquiring. The database 322 preferably stores the answers 808 according to both question syntax form and fill-in. When a user combines a particular question syntax form with a fill-in, the question processing procedure calls upon the corresponding answer in the database 322. The answer is preferably a short answer along with a link to more detailed information as described above. Finally, the database 322 stores the tracked information 810 as described above.

In an alternative embodiment, each set of question words, question syntax forms, fill-ins, and answers may be unique depending upon the context in which it is used. For example, a user browsing an on-line clothing retailer will be provided with a different set of question words, question syntax forms, and fill-ins depending upon whether the user is searching for shoes or for pants. If the user is searching for shoes, the user may be provided with questions that are more specific to shoes, such as one that inquires about available styles or sizes. In this way, a content provider can provide the user with the ability to ask questions more specific to the subject matter that is relevant to the user. Accordingly, the user will receive more accurate answers.

In an alternative embodiment, the user computer 108 (FIG. 1) is the same as the information server 102 (FIG. 1). That is, the user interfaces directly with the information server 102 (FIG. 1), rather than through the user computer 108 (FIG. 1) via the network 106 (FIG. 1). An example of this is where the information server 102 (FIG. 1) is a standalone personal computer operated by a user. Referring to FIG. 3, in this embodiment the user communicates with the information server 102 directly through the user interface 308 rather than through the network 106 (FIG. 1). The user operates the information server 102 and searches the database 322 through the user interface 308. For example, a user may want to search for information about a certain computer program that the user is running and that is stored in the memory 310 of the user's home computer (i.e. the information server 102). To illustrate, the user may want information about the functionality of a word processing program. The user may use the present invention to directly search the information server 102 for the desired information.

The foregoing description, for purposes of explanation, uses specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

1. A computer implemented method for locating and presenting electronic content, comprising:
presenting a user with a list of question words;
acquiring the identity of a question word selected by the user;
presenting a user with a list of question syntax forms associated with the selected question word;
acquiring the identity of a question syntax form selected by the user;
acquiring data from the user to combine with the selected question syntax form to construct a question;
searching an electronic database for an answer to said question; and
communicating said answer to the user.

2. The method of claim 1, wherein acquiring data from the user comprises:
providing the user with a list of fill-ins for combination with the selected question syntax form; and
receiving a selected fill-in from the list of fill-ins as the data for combining with the selected question syntax form to construct the question.

3. The method of claim 1, wherein acquiring data from the user comprises:
receiving text from the user as the data for combining with the selected question syntax form to construct the question.

4. The method of claim 3 further comprising:
comparing the received text to predefined fill-ins;
generating synonyms to the text when the text fails to match one of the predefined fill-ins; and
transmitting information for further assistance to the user when the generated synonyms fail to match one of the predefined fill-ins.

5. The method of claim 4, wherein transmitting information includes providing a telephone number.

6. The method of claim 1, further comprising storing the selected question syntax form and the data.

7. The method of claim 6, further comprising:
updating the list of question syntax forms based on the stored selected question syntax form and obtained data.

8. The method of claim 6, further comprising:
receiving text from the user as the data for combining with the selected question syntax form to construct the question; and
revising the predefined fill-ins based upon the stored received text.

9. The method of claim 1, wherein the question words are selected from a group consisting of at least one of the following: can, does, is, how, what, which, where, why, who, and when.

10. A computer program product for use in conjunction with a computer system, the computer program product comprising a computer readable storage medium and a computer program mechanism embedded therein, the computer program mechanism comprising:
a question generating procedure comprising:
instructions for presenting a user with a list of question words;
instructions for acquiring the identity of a question word selected by the user;
instructions for presenting a user with a list of question syntax forms associated with the selected question word;
instructions for acquiring the identity of a question syntax form selected by the user; and
instructions for acquiring data from the user to combine with the selected question syntax form to construct a question; and
a question processing procedure comprising:
instructions for searching an electronic database for an answer to said question; and
instructions for communicating said answer to the user.

11. The computer program product of claim 10, wherein the question generating procedure further comprises:
instructions for providing the user with a list of fill-ins for combination with the selected question syntax form; and
instructions for receiving a selected fill-in from the list of fill-ins as the data for combining with the selected question syntax form to construct the question.

12. The computer program product of claim 10, wherein the question generating procedure further comprises instructions for receiving text from the user as the data for combining with the selected question syntax form to construct the question.

13. The computer program product of claim 12, wherein the question processing procedure further comprises:
instructions for comparing the received text to predefined fill-ins;
instructions for generating synonyms to the text when the text fails to match one of the predefined fill-ins; and
instructions for transmitting information for further assistance to the user when the generated synonyms fail to match one of the predefined fill-ins.

14. The computer program product of claim 10 further comprising a question tracking procedure comprising instructions for storing the selected question syntax form and the obtained data.

15. The computer program product of claim 14, wherein the question tracking procedure further comprises instructions for revising the list of question syntax forms based on the stored selected question syntax form and data.
